(19) United States
(12) Patent Application Publication
(10) Pub. No.: US 2024/0096581 A1
(43) Pub. Date: Mar. 21, 2024

(54) ARC QUENCHING FUSE FILLER FOR CURRENT LIMITING FUSES

(71) Applicant: Littelfuse, Inc., Chicago, IL (US)

(72) Inventors: Chun-Kwan Tsang, Chicago, IL (US); Gordon Todd Dietsch, Chicago, IL (US); Irma Valeriano Santos, Chicago, IL (US)

(73) Assignee: Littelfuse, Inc., Chicago, IL (US)

(21) Appl. No.: 18/031,482

(22) PCT Filed: Oct. 26, 2020
(86) PCT No.: PCT/US2020/057351

§ 371 Date: Apr. 12, 2023

(51) Int. Cl. H01H 85/38; H01H 85/18

(52) U.S. Cl. CPC H01H 85/38; H01H 85/18; H01H 2085/388

(57) ABSTRACT

A method for producing an arc quenching fuse filler including providing a conventional fuse filler material, mixing a binder agent with the conventional fuse filler material, mixing an arc quenching promotor with the conventional fuse filler material and binder agent, and curing the binder agent, whereby granules of the arc quenching promotor are bound to granules of the conventional fuse filler material.

### BACKGROUND

### Field

The present disclosure relates generally to the field of circuit protection devices. More specifically, the present disclosure relates to an arc quenching fuse filler that includes a binder for facilitating a substantially homogeneous composition.

### Description of Related Art

Fuses are commonly used as circuit protection devices and are typically installed between a source of electrical power and a component in an electrical circuit that is to be protected. A conventional fuse includes a fusible element disposed within a hollow, electrically insulating fuse body. Upon the occurrence of a fault condition, such as an overcurrent condition, the fusible element melts or otherwise separates to interrupt the flow of electrical current through the fuse.

When the fusible element of a fuse separates as a result of an overcurrent condition, it is sometimes possible for an electrical arc to propagate between the separated portions of the fusible element (e.g., through residual, vaporized particulate between the separated portions of the fusible element). If not extinguished, the electrical arc may allow significant follow-on currents to flow to from a source of electrical power to a protected component in a circuit, resulting in damage to the protected component despite the physical opening of the fusible element. Moreover, an electrical arc may rapidly heat surrounding air and ambient particulate and may cause a small explosion within a fuse. In some cases, the explosion may burn and/or rupture the fuse body, potentially causing damage to surrounding components. The likelihood of rupture is generally proportional to the severity of the overcurrent condition. The maximum current that a chip fuse can arrest without rupturing is referred to as the fuse's “breaking capacity.” It is generally desirable to maximize the breaking capacity of a fuse without significantly increasing the size or form factor of a fuse. This is especially true in modern electric vehicle applications in which space is limited and voltage requirements are very high.

In order to minimize the detrimental effects of electrical arcing, fuses are often filled with so-called “fuse fillers” that surround a fusible element. A material that is commonly used as a fuse filler is sand. Sand acts as a heat absorber as its phase changes from solid to liquid when exposed to heat generated by an electrical arc. Thus, by quickly drawing heat away from an electrical arc, sand cools and eventually quenches the arc. While sand and other conventional fuse filler materials (e.g., calcium carbonate, steatite, etc.) are effective for providing arc quenching in certain applications, they are generally insufficient to provide fuses with the high breaking capacities and fast quenching times necessary for modern high-voltage applications (e.g., electric vehicles).

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

A method for producing an arc quenching fuse filler in accordance with the present disclosure may include providing a conventional fuse filler material, mixing a binder agent with the conventional fuse filler material, mixing an arc quenching promotor with the conventional fuse filler material and binder agent, and curing the binder agent, whereby granules of the arc quenching promotor are bound to granules of the conventional fuse filler material.

An arc quenching fuse filler in accordance with the present disclosure may include a conventional fuse filler material, an arc quenching promotor, and a binder agent that binds granules of the arc quenching promotor to granules of the conventional fuse filler material.

A fuse in accordance with the present disclosure may include an electrically insulating, tubular fuse body, electrically conductive first and second endcaps disposed over opposing ends of the fuse body, a fusible element extending through the fuse body and connecting the first endcap to the second endcap, the fusible element having a central portion adapted to melt and separate upon an overcurrent condition in the fuse, and an arc quenching fuse filler disposed within the fuse body and at least partially surrounding the central portion of the fusible element, wherein the arc quenching fuse filler includes a conventional fuse filler material, an arc quenching promotor, and a binder agent that binds granules of the arc quenching promotor to granules of the conventional fuse filler material.

### BRIEF DESCRIPTION OF THE DRAWINGS

FIGS. 1A-1D illustrate a method of manufacturing an arc quenching fuse filler in accordance with an exemplary embodiment of the present disclosure;

FIG. 2A is a cross-sectional side view illustrating a fuse in accordance with an exemplary embodiment of the present disclosure in a normal operating condition;

FIG. 2B is a cross-sectional side view illustrating the fuse of FIG. 2A upon the occurrence of an overcurrent condition.

### DETAILED DESCRIPTION

Exemplary embodiments of an arc quenching fuse filler and a method for making the same in accordance with the present disclosure will now be described more fully hereinafter with reference to the accompanying drawings. The fuse filler and method may, however, be embodied in many different forms and should not be construed as being limited to the embodiments set forth herein. Rather, these embodiments are provided so that this disclosure will convey certain exemplary aspects of the arc quenching fuse filler and method to those skilled in the art.

In one aspect, and as will be described in further detail below, the present disclosure is directed to an arc quenching fuse filler composition formed of a conventional fuse filler material (e.g., sand) mixed with an arc quenching promotor (e.g., melamine), for providing a rapid and robust arc quenching response in a fuse upon the occurrence of an overcurrent condition therein. Since the granules of the conventional fuse filler material in the composition will generally have a size and a density that differ from the size and the density of the granules of the adhesion promotor in the composition, the two materials will be prone to separation from one another when the composition is subjected to vibration (a phenomenon referred to as “granular convection”), such as when the composition is dispensed into a fuse or when the composition is in the field (e.g., in a fuse installed in an electric vehicle). Such separation may be detrimental to the efficacy of the composition. Thus, the present disclosure is further directed to a novel method for preparing the arc quenching fuse filler which involves coating the granules of the conventional fuse filler material with a binder agent prior to introduction of the adhesion promotor. Thus, when the adhesion promotor is mixed into the conventional fuse filler material, the granules of the adhesion promotor will bind to the granules of the conventional fuse filler material. As will be described in further detail below, this binding prevents the adhesion promotor from separating from conventional fuse filler material while preserving the flowability of the conventional fuse filler material.

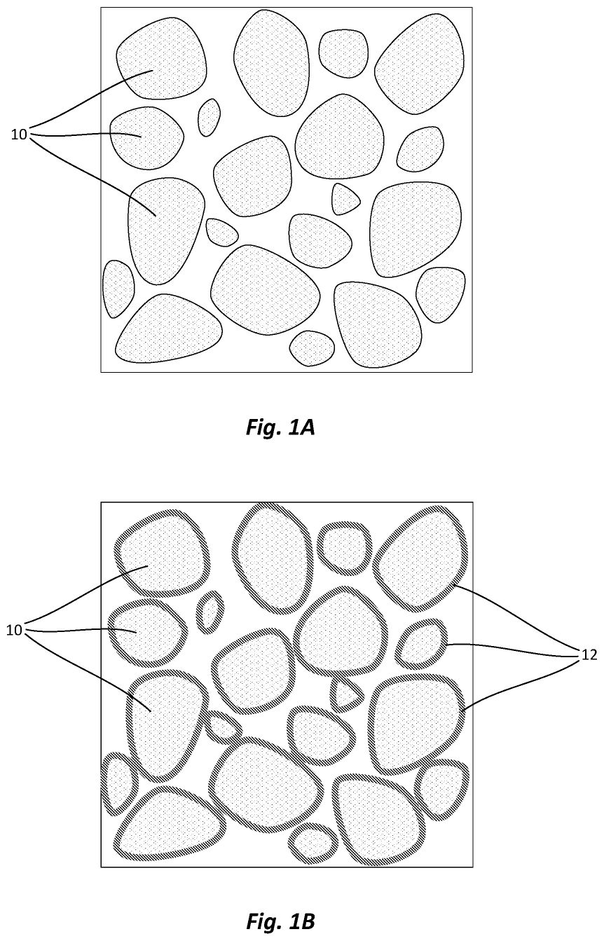

FIGS. 1A-1D illustrate a series of steps of an exemplary method of forming an arc quenching fuse filler in accordance with the present disclosure. The views shown in FIGS. 1A-1D are detailed, close-up views illustrating the individual granules of the arc quenching fuse filler and its constituent parts as further described below.

In a first step of the exemplary method shown in FIG. 1A, a quantity of a conventional fuse filler material 10 (hereinafter “the conventional filler 10”) may be provided. As used herein, the term “conventional filler 10” shall be defined to mean one or more of silica, quartz sand, calcium carbonate, calcium sulfate dihydrate, Fuller's earth, or steatite, all of which will be recognized by those of ordinary skill in the art as materials that are conventionally used as fuse fillers. The granules of the conventional filler 10 may be substantially uniform in size and shape or, as shown in FIG. 1A, may differ in size and shape. The present disclosure is not limited in this regard. In a non-limiting example, the granules of the conventional filler 10 may have a size (e.g., a length or a diameter) in a range of 150 um to 600 um.

In a further step of the exemplary method shown in FIG. 1B, a binder agent 12 may be mixed into the conventional filler 10. The binder agent 12 may be or may include a silicone-based binder, a carbon-based binder (e.g., polyvinyl alcohol, epoxy, cellulose, etc.), or an inorganic binder (e.g., calcium aluminate, alumina silicate, sodium silicate, etc.). The present disclosure is not limited in this regard. The binder agent 12 may be provided in a liquid or semi-liquid form. When mixed with the conventional filler 10, the binder agent 12 may coat the granules of the conventional filler 10 in a substantially uniform manner as shown in FIG. 1B.

In a further step of the exemplary method shown in FIG. 1C, an arc quenching promotor 14 may be mixed in with the conventional filler 10 and the binder agent 12. The arc quenching promotor 14 may be, or may include, one or more of melamine, guanidine, guanine, hydantoin, allantoin, urea, melamine-formaldehyde, melamine-cyanurate polymer, boric acid, aluminum trihydrate, and derivatives and mixtures thereof in a powdered or granular form. The granules of the arc quenching promotor 14 may be substantially uniform in size and shape or, as shown in FIG. 1C, may differ in size and shape. The present disclosure is not limited in this regard. In a non-limiting example, the granules of the arc quenching promotor 14 may have a size (e.g., a length or a diameter) in a range of 5 um to 60 um. Generally, the granules of the arc quenching promotor 14 will be smaller than the granules of the conventional filler 10. For example, in various embodiments the granules of the arc quenching promotor 14 may be 0.3%-10% of the size of the granules of the conventional filler 10. The present disclosure is not limited in this regard. When the arc quenching promotor 14 is mixed in with the conventional filler 10 and the binder agent 12, the granules of the arc quenching promotor 14 may adhere to the granules of the conventional filler 10 via the binder agent 12. For example, one or more granules of the arc quenching promotor 14 may bind to each granule of the conventional filler 10 as shown in FIG. 1C.

In a further step of the exemplary method shown in FIG. 1D, the binder agent 12 in the above described mixture may be dried or cured, such as by subjecting the mixture to heat curing, humidity curing, UV curing, etc. Once the binder agent 12 is cured thusly, the granules of the arc quenching promotor 14 may be firmly adhered to the granules of the conventional filler 10, and the arc quenching fuse filler 16 of the present disclosure may be complete and ready for implementation within a fuse as further described below. Importantly, the flowability of the arc quenching fuse filler 16 may be the same as, or similar to, the flowability of the conventional fillers (e.g., silica, quartz sand, etc.). Thus, the arc quenching fuse filler 16 may be poured, flowed, or otherwise dispensed into a fuse body using conventional vibration techniques used to dispense conventional fillers (e.g., with a conventional sand filling machine). Since the granules of the arc quenching promotor 14 are bound to the granules of the conventional filler 10, such dispensation may be achieved without the granules of the arc quenching promotor 14 separating from the granules of the conventional filler 10, thus preserving the efficacy of the composition. Similarly, the homogeneity and efficacy of the arc quenching fuse filler 16 may be maintained when the composition is exposed to vibration in the field, such as when the arc quenching fuse filler 16 is implemented in a fuse installed in a vehicle that experiences or generates vibration when driven.

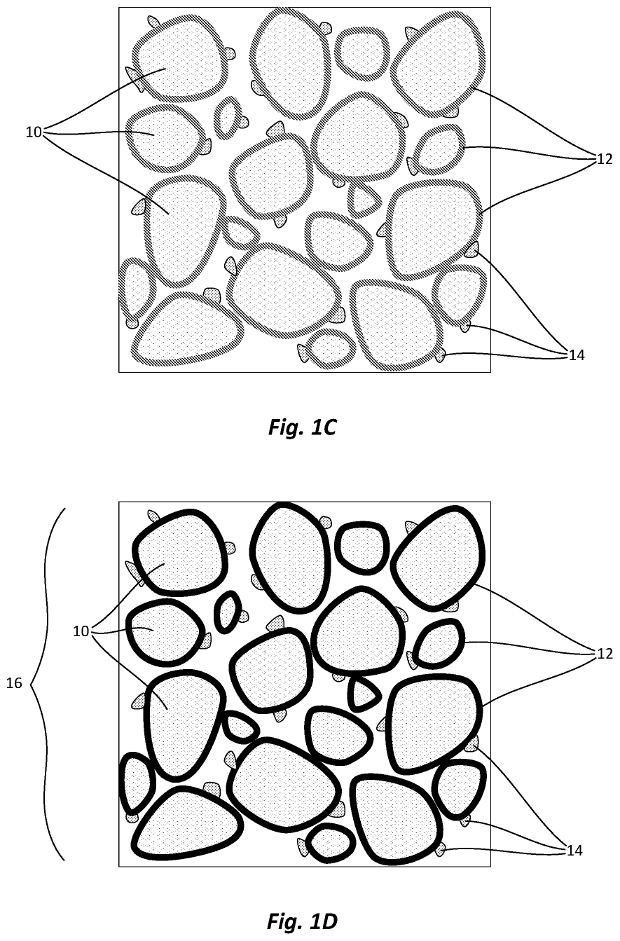

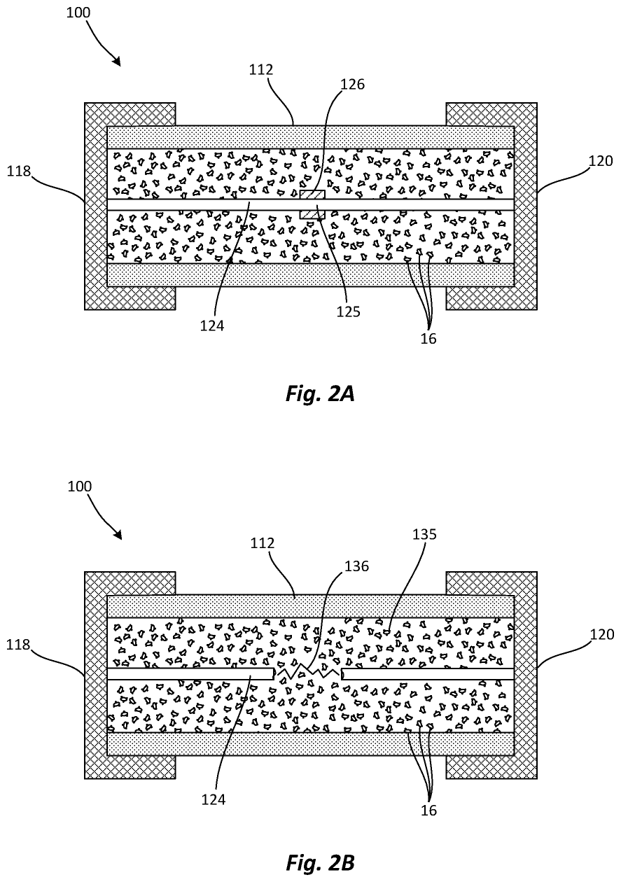

Referring to FIG. 2A, a cross sectional side view illustrating an exemplary fuse 110 incorporating the above described arc quenching fuse filler is shown. In various embodiments, the fuse 110 may be a cartridge fuse having a tubular fuse body 112. The present disclosure is not limited in this regard. In various alternative embodiments, the fuse 110 may be a surface mount fuse or other type of fuse having a fusible element extending through a generally hollow fuse body. The fuse body 112 may be formed of an electrically insulating and preferably heat resistant material. Examples of such materials include, but are not limited to, ceramic, glass, and glass fiber-filled melamine-formaldehyde resin.

A pair of electrically conductive endcaps 118, 120 may be disposed on opposing ends of the fuse body 112 and may be adapted to facilitate electrical connection of the fuse 110 within a circuit. A fusible element 124 may extend through the hollow interior of the fuse body 112 and may be connected to the endcaps 118, 120 in electrical communication therewith, such as by solder. The endcaps 118, 120 may be formed of an electrically conductive material, including, but not limited to, copper or one of its alloys, and may be plated with nickel or other conductive, corrosion resistant coatings. The fusible element 124 may be formed of an electrically conductive material, including, but not limited to, tin or copper, and may be configured to melt and separate upon the occurrence of a predetermined fault condition, such as an overcurrent condition in which an amount of current exceeding a predefined maximum value flows through the fusible element 124. This maximum value is commonly referred to as the “rating” of the fuse 110.

The fusible element 124 may be any type of fusible element suitable for a desired application, including, but not limited to, a wire, a corrugated strip, a wire wound about an insulating core, etc. The central portion 125 of the fusible element 124 may be thinned, narrowed, perforated, or otherwise weakened relative to other portions of the fusible element 124 to ensure that the fusible element 124 separates at the central portion 125. In various embodiments, a quantity of dissimilar metal 126 (hereinafter “the metal spot 126”), sometimes referred to as a “Metcalf spot,” may be applied to the central portion 125 of the fusible element 124. The metal spot 126 may be formed of one or more of nickel, indium, silver, tin, or other metal having a lower melting temperature than the base metal (e.g., copper) from which the fusible element 124 is formed. The metal spot 126 may therefore melt more readily than the base metal of the fusible element 124 upon the occurrence of an overcurrent condition and may diffuse into the base metal. The base metal of the fusible element 124 and the dissimilar metal of the metal spot 126 are chosen such that the diffusion of one into the other results in an intermetallic phase with a lower melting temperature and higher resistance than those of the base metal alone, which causes the central portion 125 of the fusible element 124 to melt more readily than other portions of the fusible element 124. In various embodiments of the fuse 110 the metal spot 126 may be entirely omitted.

The fuse body 112 may be partially or entirely filled with the above described arc quenching fuse filler 16 of the present disclosure, and the arc quenching fuse filler 16 may partially or entirely surround the fusible element 124 as shown FIG. 2A. In various alternative embodiments, the fuse body 112 may include numerous internal walls or barriers that define an enclosed chamber surrounding the central portion 125 of the fusible element 124, and only such chamber may be filled with the arc quenching fuse filler 16. The present disclosure is not limited in this regard.

Upon the occurrence of an overcurrent condition in the fuse 110, the central portion 125 of the fusible element 124 may melt and separate, and an electrical arc 136 may propagate across the gap left between the separated ends of the fusible element 124 as shown in FIG. 2B. Heat from the electrical arc 136 may burn and decompose the conventional filler 10 (e.g., silica) in the arc quenching fuse filler 16. The conventional filler 10 may absorb the heat from the electrical arc 136 as it melts and changes from solid to liquid, thus cooling the electrical arc 136. The heat from the electrical arc 136 may simultaneously also burn and decompose the arc quenching promotor 14 (e.g., melamine, guanidine, guanine, hydantoin, etc. as listed above) in the arc quenching fuse filler 16. As the arc quenching promotor 14 decomposes, it undergoes an endothermic chemical reaction that absorbs heat. The electrical arc 136 is thereby rapidly cooled. Furthermore, depending on the specific arc quenching promotor 14 that is implemented in the arc quenching fuse filler 16, certain byproducts of the endothermic chemical reaction may be nonconductive gases (e.g., ammonia) that may hinder the ability of the electrical arc 136 to persist. Thus, the arc quenching fuse filler 16 may, upon the occurrence of an electrical overcurrent condition in the fuse 110, absorb heat and release gases that are unfavorable to sustaining the electrical arc 136, which may contribute to arc quenching that is are more rapid and more robust than can be achieved with conventional fuse filler materials alone. The breaking capacity of the fuse 110 is therefore significantly enhanced relative to fuses that employ conventional fuse filler materials alone, components that are connected to the fuse 110 and/or that are located in the proximity of the fuse 110 are protected from damage that might otherwise result if the electrical arc 136 were allowed to persist.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A method for producing an arc quenching fuse filler comprising:
providing a conventional fuse filler material;
mixing a binder agent with the conventional fuse filler material;
mixing an arc quenching promotor with the conventional fuse filler material and binder agent; and
curing the binder agent, whereby granules of the arc quenching promotor are bound to granules of the conventional fuse filler material.

2. The method of claim 1, wherein the conventional fuse filler material includes at least one of silica, quartz sand, calcium carbonate, calcium sulfate dihydrate, Fuller's earth, and steatite.

3. The method of claim 1, wherein the arc quenching promotor includes at least one of melamine, guanidine, guanine, hydantoin, allantoin, urea, melamine-formaldehyde, melamine-cyanurate polymer, boric acid, aluminum trihydrate, and derivatives thereof.

4. The method of claim 1, wherein the binder agent includes at least one of silicone, polyvinyl alcohol, epoxy, cellulose, calcium aluminate, alumina silicate, and sodium silicate.

5. The method of claim 1, wherein the granules of the arc quenching promotor have a length or a diameter in a range of 5 um to 60 um.

6. The method of claim 1, wherein the granules of the arc quenching promotor are 0.3%-10% of a size of the granules of the conventional fuse filler material.

7. The method of claim 1, wherein curing the binder agent includes subjecting the mixed conventional fuse filler material, binder agent, and arc quenching promotor to one of heat curing, humidity curing, and UV curing.

8. An arc quenching fuse filler comprising:
a conventional fuse filler material;
an arc quenching promotor; and
a binder agent that binds granules of the arc quenching promotor to granules of the conventional fuse filler material.

9. The arc quenching fuse filler of claim 8, wherein the conventional fuse filler material includes at least one of silica, quartz sand, calcium carbonate, calcium sulfate dihydrate, Fuller's earth, and steatite.

10. The arc quenching fuse filler of claim 8, wherein the arc quenching promotor includes at least one of melamine, guanidine, guanine, hydantoin, allantoin, urea, melamine-formaldehyde, melamine-cyanurate polymer, boric acid, aluminum trihydrate, and derivatives thereof.

11. The arc quenching fuse filler of claim 8, wherein the binder agent includes at least one of silicone, polyvinyl alcohol, epoxy, cellulose, calcium aluminate, alumina silicate, and sodium silicate.

12. The arc quenching fuse filler of claim 8, wherein the granules of the arc quenching promotor are 0.3%-10% of a size of the granules of the conventional fuse filler material.

13. The arc quenching fuse filler of claim 8, wherein the arc quenching fuse filler has a flowability that facilitates dispensation of the arc quenching fuse filler into a fuse using a conventional sand filling machine.

14. A fuse comprising:
an electrically insulating, tubular fuse body;
electrically conductive first and second endcaps disposed over opposing ends of the fuse body;
a fusible element extending through the fuse body and connecting the first endcap to the second endcap, the fusible element having a central portion adapted to melt and separate upon an overcurrent condition in the fuse; and
an arc quenching fuse filler disposed within the fuse body and at least partially surrounding the central portion of the fusible element, the arc quenching fuse filler comprising:
a conventional fuse filler material;
an arc quenching promotor; and
a binder agent that binds granules of the arc quenching promotor to granules of the conventional fuse filler material.

15. The fuse of claim 14, wherein the conventional fuse filler material includes at least one of silica, quartz sand, calcium carbonate, calcium sulfate dihydrate, Fuller's earth, and steatite.

16. The fuse of claim 14, wherein the arc quenching promotor includes at least one of melamine, guanidine, guanine, hydantoin, allantoin, urea, melamine-formaldehyde, melamine-cyanurate polymer, boric acid, aluminum trihydrate, and derivatives thereof.

17. The fuse of claim 14, wherein the binder agent includes at least one of silicone, polyvinyl alcohol, epoxy, cellulose, calcium aluminate, alumina silicate, and sodium silicate.

18. The fuse of claim 14, wherein the granules of the arc quenching promotor are 0.3%-10% of a size of the granules of the conventional fuse filler material.
